(19) United States
(12) Patent Application Publication
(10) Pub. No.: US 2007/0251056 A1
(43) Pub. Date: Nov. 1, 2007

(54) Hinge Device

(75) Inventor: Tatsuzo Aoyagi, Minami Alps-shi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, omitted

(73) Assignee: NISCA CORPORATION, Yamanashi-ken (JP)

(21) Appl. No.: 11/742,323

(22) Filed: Apr. 30, 2007

(30) Foreign Application Priority Data
Apr. 28, 2006 (JP) JP-2006-124568

(51) Int. Cl. E05D 7/00

(52) U.S. Cl. 16/221

(57) ABSTRACT

A first mounting member fastens to a lower unit such as an image reading apparatus, and a second mounting member fastens to an upper unit such as a document feeder; a rotary shaft (hinge pin) rotatably connects the first and second mounting members. The first mounting member is provided with a compression spring, and with a brake member having a cam surface that engages the spring. A shift mechanism vertically shifts the brake member, compression spring, and second mounting member unitarily. Alternatively, the shift mechanism adjusts the height-level position where a pressing engager provided on one end of the compression spring and the cam surface engage, and the axle-support position of the rotary shaft. A hinge open/closably connecting the upper unit and lower unit can by a simple structure be easily adjusted heightwise, enabling continually stable opening/closing operations without exerting changes to the spring or other hinge components.

### BACKGROUND OF THE INVENTION

1. Technical Field

The present invention, involving hinge fittings that connect devices to be free to open/close in a doorlike fashion, relates to improvements in hinge devices which, in open/closably connecting to a lower unit such as an image-reading device, for example, an upper unit such as a document (original) holder or a document feeder, make it possible to adjust the height position of the upper unit with respect to the lower unit.

2. Description of the Related Art

With image reading devices such as scanners, in implementations in which an original is set onto the reading platen, conventionally the original cover (platelike pressing member) that covers the original on the platen is installed free to open/close over the image reading apparatus in a doorlike fashion. And the same is true of image-reading devices equipped with an automatic document feeder (ADF) that automatically feeds originals onto the upper part of the reading platen: The ADF is open/closably mounted onto the upper part of the scanner. Thus, in image reading devices in which an upper unit (an original cover or an ADF device) is open/closably mounted onto the upper part of the reading platen, in general the upper unit and the lower unit are connected with hinge devices.

The hinge device connects, free to rotate about a rotary shaft (the hinge shaft), a first mounting member fastened to the upper unit and a second mounting member fastened to the lower unit, with the hinge device being provided in one or a plurality of locations to install the upper unit free to open off of and close onto the lower unit. In such cases, if the weight of the upper unit is heavy, as with document feeders for example, interposing a compression spring between the first and the second mounting members facilitates the opening/closing of upper unit. Such hinge devices require adjusting the height positions of the upper and lower units. For example, in implementations in which the upper unit is set onto the upper face of the lower unit and connected to it with hinge devices, if the mounting position dimensions differ by discrepancies in the framework, etc. of each unit, a portion of the upper unit can sometimes become lifted off and will not fit snugly onto the upper face of the lower unit. Such misalignment of the mating surfaces is known to give rise to the same sort of lifting-off in situations in which slippage develops among the constituent parts in the course of using the apparatus, leading to impeded opening/closing of the upper unit, and malfunctioning of the hinge devices.

In this regard, to date a hinge device whereby the height positions of the upper and the lower units are adjusted has been proposed, for example in Japanese Unexamined Utility Model Application Pub. No. H07-49478 (FIG. 2). Proposed in that publication, a main unit mounting member for a lower unit (a copier) and a unit mounting member for an upper unit (the ADF device) are rotatably connected by a hinge device. The mounting angles of the unit mounting member and upper unit are adjusted with position-adjustment screws. In the same way, Japanese Unexamined Pat. App. Pub. No. 2003-280112 (FIG. 2) discloses a hinge structure equipped with a rocking lever between the main unit mounting member fitted to the copier and the unit mounting member fitted to an original pressing plate, and with a compression spring built into the rocking lever.

In the same publication, a cam is provided on the main unit mounting member, with the device being configured so that elastic force of a compression spring acts on the cam surface, making it easier to open and close the original pressing plate because the spring alleviates the weight of the plate. A height adjustment screw is disposed on the main unit mounting member to adjust the angular position of the mounting member; and a stop member, operating linked with the screw, regulates the angular position of the unit mounting member. In this way, such a conventional hinge structure sets the height position of the upper unit by adjusting the height positions of the upper and lower units, and adjusting the angular position of the mounting member for the upper unit.

Meanwhile, another known hinge structure is, as shown in FIG. 9, a structure in which the mounting member of the lower unit and the mounting member of the upper unit are rotatably connected by a hinge pin, and a compression spring is provided on one of either member and a slidable cam is provided on the other member to alleviate the weight of the top member. In order to adjust the height position of the upper unit with this hinge structure, conventionally the interposing of a spacer-like adjusting member in between the upper-unit mounting member the unit has been employed.

To openably connect the upper unit, such as a document feeder, to the lower unit, such as an image reading apparatus, both units must be connected with hinge means at one or a plurality of locations on both units. This hinge means has a rotary shaft that connects the mounting members of the upper and lower units, wherein a spring is provided on one of the upper or lower mounting members and a cam member is provided on the other member to facilitate the opening/closing operation. To adjust the height positions of the upper and lower units, conventionally either the angular position of the upper mounting member is adjusted, or a spacer member is provided between the upper mounting member and the upper unit and the height is adjusted with an adjusting means such as a screw. A problem with this kind of conventional device is that the acting force of the spring can vary depending on the height position adjustment.

This problem will now be described with reference to FIG. 9. With respect to its center of gravity position W1, the center of gravity of the upper unit shifts to W2 when the height position is shifted from H1 to HH2 by means of the spacer member SP. This shift in the center of gravity changes the distance between the point SO where the spring S and the cam member engage, and the center of gravity from L1 to L2, such that the torque acting on the rotary shaft O is altered. The torque acting on the rotary shaft will consequently differ from the preset spring force (design value) depending on the height position adjustment, and this will make the force of the operation of opening/closing the upper unit to be heavy in some situations, or in others, to be lighter than is necessary.

In particular, attempting to bring the upper unit to a standstill in a predetermined angular position by the acting force of the spring will disrupt the balance, with respect to the rotary shaft, between the weight (center of gravity position) of the upper unit and the elastic force of the spring, making it impossible to bring the upper unit to a standstill in the predetermined angular position. For example, in order to set an original into position on the platen in the lower unit, swinging upward and attempting to keep the upper unit in a predetermined angular position, will disrupt the balance, the acting force of the spring, due to the height position adjustment, causing the annoyance of the upper unit dropping.

### BRIEF SUMMARY OF THE INVENTION

Given this need in the art, a principal issue for the present invention is to make available a hinge device that with a simple structure facilitates height position adjustment of the hinge open/closably connecting an upper unit to a lower unit, and that, without the height position adjustment exerting any alteration on the hinge working parts, such as the spring, enables continually stable, normal opening/closing actions. A further issue in the present invention is to make it possible to connect a document feeder or like upper unit to a scanner device or like lower unit, to install the upper unit in the proper attitude, thereby making available a document feeder and image-reading apparatus that enable stabilized opening/closing actions.

The present invention adopts the following configuration to solve the aforementioned problems.

A first mounting member mounted to a lower unit, such as an image reading apparatus, and a second mounting member mounted to an upper unit, such as an automatic document feeder, are provided; the first mounting member and second mounting member are rotatably connected by a rotary shaft (hinge pin). A compression spring is provided on one of the first mounting member or the second mounting member; a brake member having a cam surface that engages this compression spring is equipped on the other. A shift means is provided that unitarily shifts the brake member, the compression spring and the second mounting member up and down. Alternatively, a shift means is provided that adjusts the height of the position where a pressing engager provided on one end of the compression spring and the cam surface engage, and the axle-support position of the rotary shaft.

By unitarily shifting the brake member, the compression spring and the second mounting member up and down (vertically), it is possible to adjust the height position of the upper unit with regard to the lower unit without changing the rotating shaft axle-support position and spring acting point (engaging position). Furthermore, a continual, stable fixed braking action is attained without change because the members are moved simultaneously the same amount in the height direction with the braking force from the spring acting on the rotary shaft with this position adjustment.

### EFFECTS OF THE INVENTION

By shifting the brake member, the compression spring and the second mounting member in up and down directions as one body, the present invention adjusts the height position of the upper unit with regard to the bottom, and enables adjustments of the height position of both at the bearing position of the hinge rotary shaft and the braking compression spring acting position. Therefore, because the spring acting point and bearing point are moved simultaneously the same amount in the height direction with the braking force from the spring acting on the rotary shaft with this position adjustment, there is no change in the spring acting force. Therefore, when initially installing the upper unit onto the bottom, or when adjusting the upper unit after it has been in use, even when the height position of the upper unit is adjusted by an adjusting screw, the center of gravity of the upper unit with regard to the rotary shaft and the positional relationship of the point of action of the compression spring remain constant. The predetermined setting values are maintained and the braking force of the compression spring with regard to the upper unit remains unchanged by this height position adjustment.

This enables the stable opening and closing of the upper unit, and constantly smooth operation. Particularly, when the upper unit is held at a predetermined angular position by the balance between its weight, and the braking force of the compression spring, the preset angle is held constant and stable without any disruption to that balance by adjusting the height position of the upper unit, and making it easier to set originals on the platen.

### BRIEF DESCRIPTION OF THE SEVERAL VIEWS OF THE DRAWINGS

FIG. 1 is an external perspective view of an embodiment of a hinge device according to the present invention;

FIG. 2 is a sectional view of the hinge device of FIG. 1;

FIGS. 3A and 3B are explanatory drawings of the cam shape of a cam surface in the hinge device of FIG. 1, wherein FIG. 3A shows a cam shape of the hinge device of FIG. 1, and FIG. 3B shows a cam surface that is different from the one shown in FIG. 1;

FIGS. 4A and 4B show a state of height position adjustment of the hinge device of FIG. 1, wherein FIG. 4A shows the hinge device adjusted to a low position, and FIG. 4B shows the hinge device adjusted to a high position;

FIG. 5 is an explanatory drawing of a guide structure that guides a movement of a brake member in a height direction in the hinge device of FIG. 1;

FIG. 6 is an explanatory drawing of a stop structure that regulates an opening angle of the hinge device of FIG. 1;

FIG. 7 is a perspective view of an ADF in which the present invention is adopted;

FIG. 8 is an explanatory view of an ADF and an image reading apparatus configuration in which the present invention is adopted; and

FIG. 9 is an explanatory drawing of a height adjustment method in a conventional hinge device.

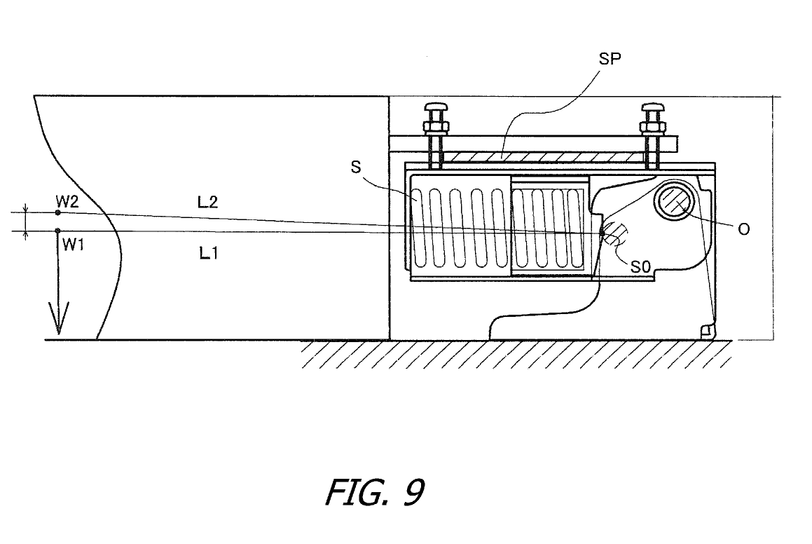

### DETAILED DESCRIPTION OF THE INVENTION

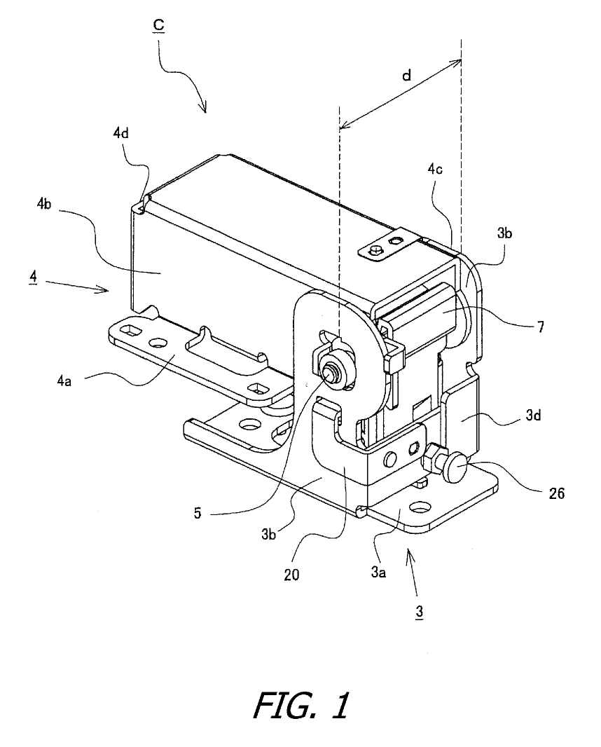

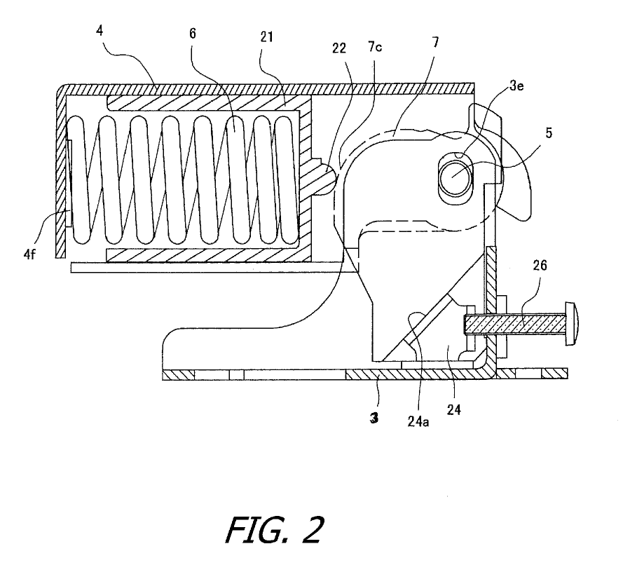

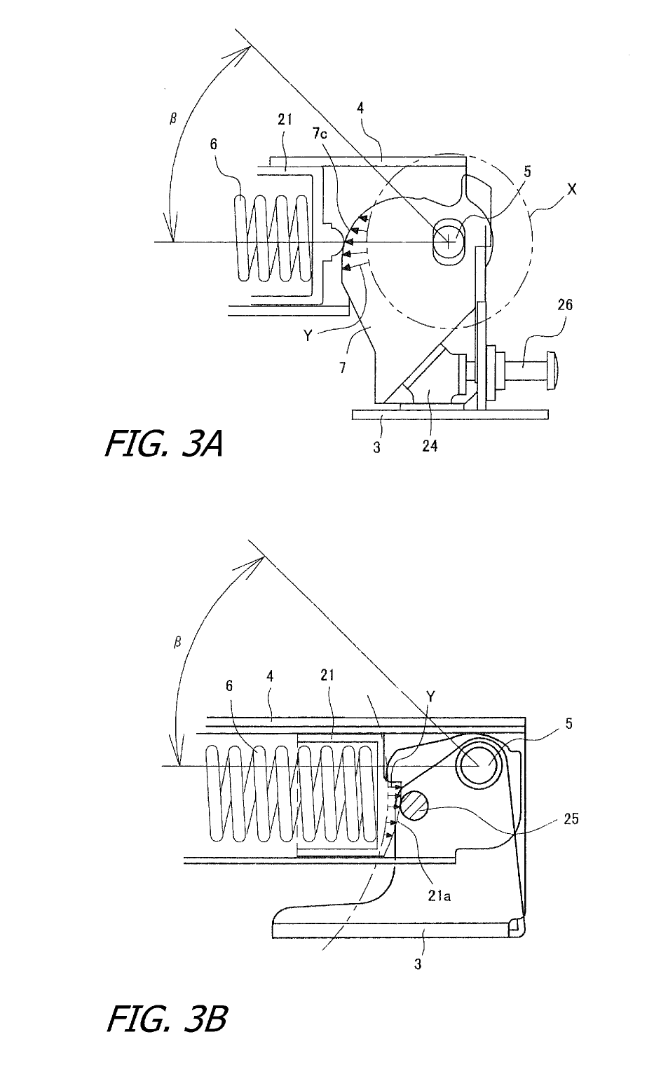

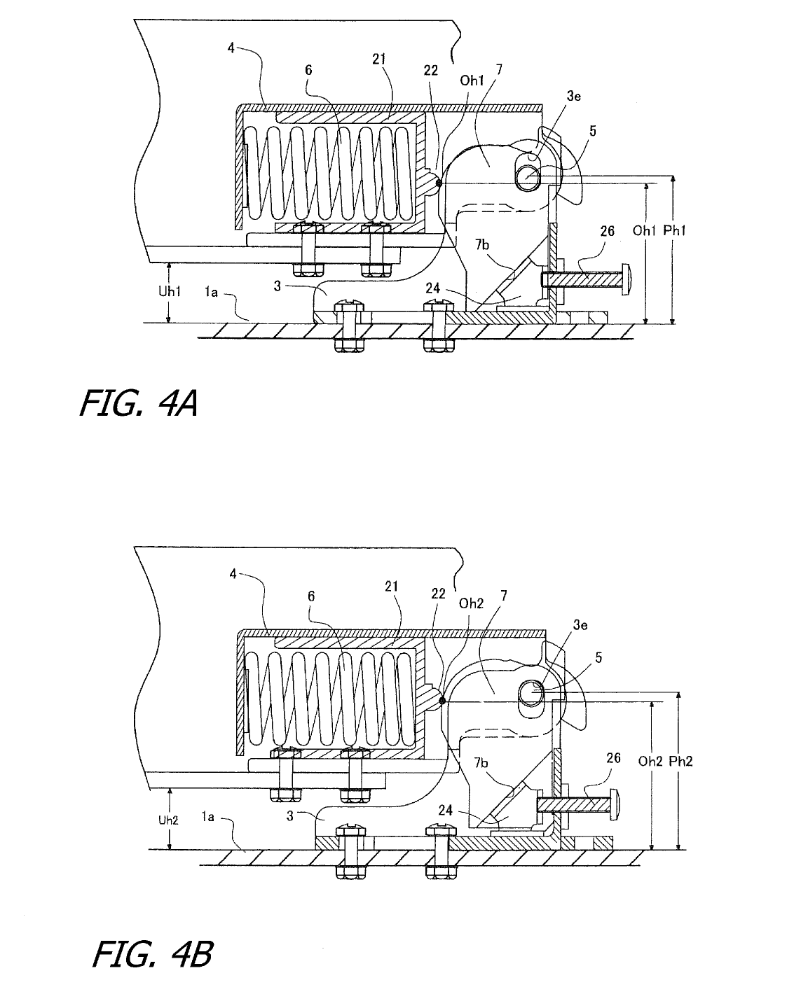

Preferred embodiments of a hinge device according to the present invention will now be explained with reference to the drawings provided. FIG. 1 is a perspective view of the hinge device according to the present invention; FIG. 2 is a sectional view of the hinge device; FIGS. 3A and 3B are explanatory views of the cam surface; and FIGS. 4A and 4B are explanatory drawings of height position adjustments of the hinge device.

Initially, an explanation will be provided for the hinge device C according to the present invention. Hinge device C is equipped with a first mounting member 3 that mounts to a lower unit 1, such as an image reading apparatus or the like; and a second mounting member 4 that mounts to an upper unit 2, such an automatic document feeder (hereinafter referred to simply as ADF). The first mounting member 3 and the second mounting member 4 have mounting seats 3a and 4a respectively; the mounting seats are composed of a metal material and have adequate mechanical strength to endure force acting on them from the image reading apparatus and ADF. The first mounting member 3 is equipped with a sectional U-shaped bottom wall portion (mounting seat) 3a; opposing side walls 3b and 3c bent from the bottom wall portion 3a; and a backside wall 3d that connects both side walls. The bottom wall portion (mounting seat 3a), side wall portions (opposing side walls 3b and 3c) and backside wall portion (backside wall 3d) are formed of one body by bending a metal plate. A socket 3e that mates with the rotary shaft (hinge shaft) 5 is provided in the opposing side walls 3b, 3c opposed at a predetermined distance (d) in the drawing. The socket 3e is formed to be elongated in the up and down directions of FIG. 2, as described in further detail below.

The second mounting member 4 is equipped with a mounting seat 4a; opposing side walls 4b, 4c bent from the mounting seat 4a; and a backside wall 4d that connects the opposing side walls 4b and 4c. The gap of the opposing side walls 4b, 4c is smaller than the gap (d) of the opposing side walls 3b, 3c of the first mounting member 3, and is configured to a width of (d-α) to fit into the inside of the first mounting member 3. The socket 4e is formed in the opposing side walls 4b and 4c and connects to the socket 3e formed in the opposing side walls 3b and 3c. Socket 4e is formed to substantially the same diameter as the external diameter of the rotary shaft 5. The rotary shaft 5 fits into the socket 4e and the socket 3e formed to be elongated in the up and down directions of FIG. 2 in the opposing side walls 3b and 3c of the first mounting member 3.

In this way, the first and second mounting members 3 and 4 are mutually rotatably connected by the rotary shaft 5; the rotary shaft 5 is composed of a pin member having adequate mechanical strength and forms the center of the hinge. The first mounting member 3 rotates around the rotary shaft 5, and is supported to move in a thrust direction in up and down directions of FIG. 2 in the elongated hole formed in the member 3. A compression spring 6 is installed in the second mounting member 4 as described below; a brake member 7 is installed in the first mounting member 3.

One end (the base end) of the compression spring 6 is mounted to the second mounting member 4. A bent spring fastening wall 4f is provided on the backside wall 4d; the base end of the compression spring 6 is anchored to this fastening wall 4f. A casing member 21 is mated to the leading edge (the other end) of the compression spring 6, and is slidably mated between the opposing side walls 4b, 4c. A pressing engager 22 is disposed on the casing member 21. In the drawing, the pressing engager 22 is a rounded projection that uses springing force by engaging a cam surface 7c of the brake member 7, described in further detail below. Therefore, the compression spring 6 is mounted to the second mounting member 4, its base end supported, so that there is elastic force acting to the right direction of FIG. 2 via a slide holder (casing member) 21. The brake member 7 is disposed between the opposing side walls 3b, 3c on the first mounting member 3. The brake member 7 is provided the cam surface 7c that touches the pressing engager 22, and is supported by the first mounting member 3. In the drawing, the brake member 7 is matingly supported on the rotary shaft 5 supported by the first mounting member 3, and supported by a spacer member 24 disposed on the first mounting member 3. This brake member 7 transmits the elastic force of the compression spring 6 supported by the second mounting member 4 as described above, to the first mounting member 3 to urge the first and second mounting members 3 and 4 to widen or move apart. The cam surface 7c acts as a brake to stop the rotation of the second mounting member 4 with that friction force. Of particular note, the cam surface 7c has a cam surface where engaging forces with the pressing engager 22 differ depending on the angular position of the rotary shaft 5. As shown in FIG. 3A, the cam surface 7c is shaped so that the rotating torque around the rotary shaft 5 is low because of the elastic force of the compression spring 6 when the opening angle (β in the drawing) of the first and second mounting members 3 and 4 is large. When the opening angle (β) is small, the rotating torque caused by the action of the spring 6 is large. In other words, due to the relationship with the opening angle β, the displacement magnitude Y decreases with regard to the circle X (an equidistant curve) drawing using the rotary shaft 5 as the center of the circle, as the opening angle β increases in size.

The device shown in FIG. 2 has a cam surface 7c on the brake member 7 disposed on the first mounting member 3, but it is also possible to form the cam surface 7c on the pressing engager 22, as shown in FIG. 3B. A cam surface 21a is formed on the casing member 21 described above; the cam surface of the first mounting member 3 is composed of a pin 25, for example. The cam surface 21a formed on the casing member 21 is composed of an oblique surface so that as the opening angle β of the first and second mounting members 3 and 4 increases in size, the cam displacement magnitude Y becomes smaller. In this way, the force (urging force) of the compression spring 6 is set to be different depending on the opening angle of the rotary shaft 5 so that when the upper unit 2 is fastened to the second mounting member 4, the weight of the device acting on the center of gravity of the upper unit 2 generates rotating torque for the upper unit 2 to fall downward around the rotary shaft 5. The torque will increase as the opening angle becomes smaller.

The elastic force of the compression spring 6 is set to increase as the opening angle decreases so the force acting from the upper unit 2 and the urging force of the compression spring 6 are balanced. This makes the opening and closing of the upper unit 2 smoother. Therefore, the rotating torque of the upper unit 2 that acts on rotary shaft 5 and the rotating torque caused by the urging force of the compression spring 6 are balanced for the weight of the upper unit 2 and its opening speed. The urging force is set so that the upper unit 2 closes over the lower unit 1 at a slow speed, and can be opened from that closed state with little operating force.

The present invention provides a way to adjust the height position of the upper unit 2 when it is installed via the hinge device C to the lower unit 1 by calculating the spring force of the compression spring 6 as described above. When the upper unit 2 is openably installed to the lower unit 1 by the hinge device C, differences in part precision, or play that is generated by repeatedly opening and closing the device can cause the upper unit 2 to become out of alignment with the lower unit 1. Conventionally, a spacer or adjustment screw is used to adjust the height position or the installation angle when the second mounting member 4 is fastened to the upper unit 2 so that the bottom surface of the upper unit 2 fits closely to the top surface of the lower unit 1.

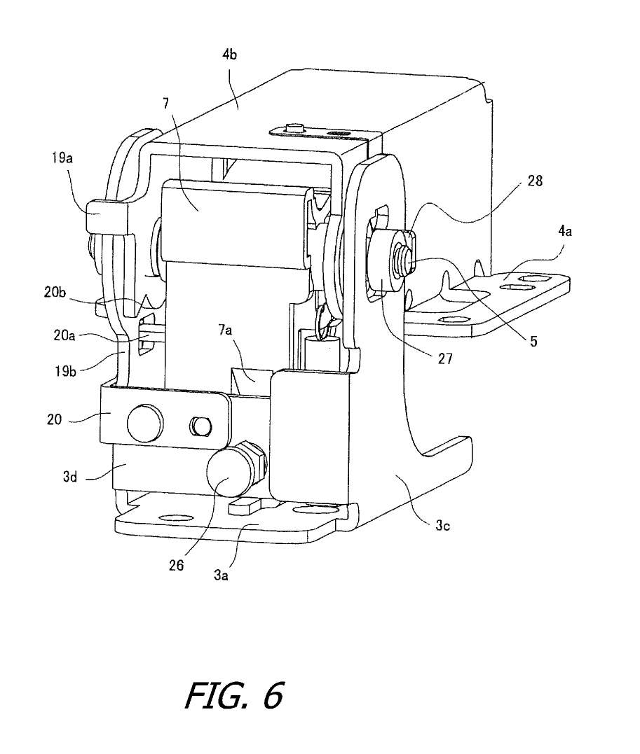

However, even if the compression spring 6 strength is calculated to open and close a predetermined number of times set at the time it was designed, when the height position or angle of the upper unit 2 changes, the distance or angle between the rotary shaft 5 and upper unit 2 center of gravity will change. That change will disrupt the balance with the urging force of the compression spring 6. Also, the brake member 7 is supported by the spacer member 24 equipped on the first mounting member 3. The spacer member 24 is formed to a wedge shape having an oblique surface 24a to move the brake member 7 in the up and down directions. A concave groove 7a shown in FIG. 6 is formed in the backside of the brake member 7 and the spacer member 24 having the wedge-shaped oblique surface 24a mates with this concave groove 7a.

Also this spacer member 24 is linked to an adjustment screw 26 that meshes with the backside wall 3d. The rotary shaft 5 is inserted into the brake member 7; the rotary shaft 5 is matingly supported in the socket 3e formed in the opposing side walls 3b, 3c of the first mounting member 3. The socket 3e is elongated to allow movement in the up and down directions, as described above. In other words, as shown in FIG. 4A, the bottom surface 7b of the brake member 7 is supported by the wedge-shaped spacer member 24, and the rotary shaft 5 is inserted into the brake member 7 in this state. The rotary shaft 5 is matingly supported in the socket formed in the opposing side walls 3b, 3c of the first mounting member 3. Also, when the wedge-shaped spacer member 24 moves in the left direction of FIGS. 4A and 4B, the entire brake member 7 is move upward and the rotary shaft 5 is raised in the socket 3e.

Therefore, if the spacer member 24 is moved to the right side of FIG. 4A by the adjustment screw 26, the brake member 7 and rotary shaft 5 move to their lowest positions in FIG. 4A. The second mounting member 4 linked to the rotary shaft 5 also moves to its lowest position. Conversely, if the spacer member 24 is moved to the left side of FIG. 4A, the rotary shaft 5 and the second mounting member 4 are moved to their uppermost positions. As shown in FIG. 4A, the upper unit 2 can be adjusted to heights between the lowest position (see FIG. 4B). At this time, the rotary shaft 5 is also adjusted the same amount in height between Ph1 and Ph2, and the engaging point of the pressing engager 22 of the compression spring 6 and cam surface 7c of the brake member 7 is adjusted in height the same amount between Oh1 and Oh2. Note that each of the height adjustments shown in FIGS. 4A and 4B are based on the installation surface of the lower unit 1 (1a in the same drawings).

Because the hinge device C has the configuration described above, it uses a shift means composed of the adjustment screw 26 and spacer member 24 to adjust the height Ph of the bearing position of the rotary shaft 5, the height position Oh of the engaging position of the pressing engager 22 and cam surface 7c, and the height Uh of the unit installation surface 4d of the second mounting member 4. Specifically, the shift means moves the rotary shaft 5 upward and downward along the socket (elongated hole) from its lowest position in FIG. 4A to its highest position in FIG. 4B, and moves the same amount in the upward and downward directions from Ph1 to Ph2, Oh1 to Oh2, and from Uh1 to Uh2. Therefore, the elastic force of the compression spring 6 acts on the cam surface from the pressing engager 22 regardless of the height position, but there is no change in the distance between the engaging position and the rotary shaft. Furthermore, there is no change in the distance of the unit installation surface 4d and the rotary shaft 5. Therefore, the spring force, set when designing the device, will maintain a stable and smooth opening operation without being disturbed by adjusting the height positions.

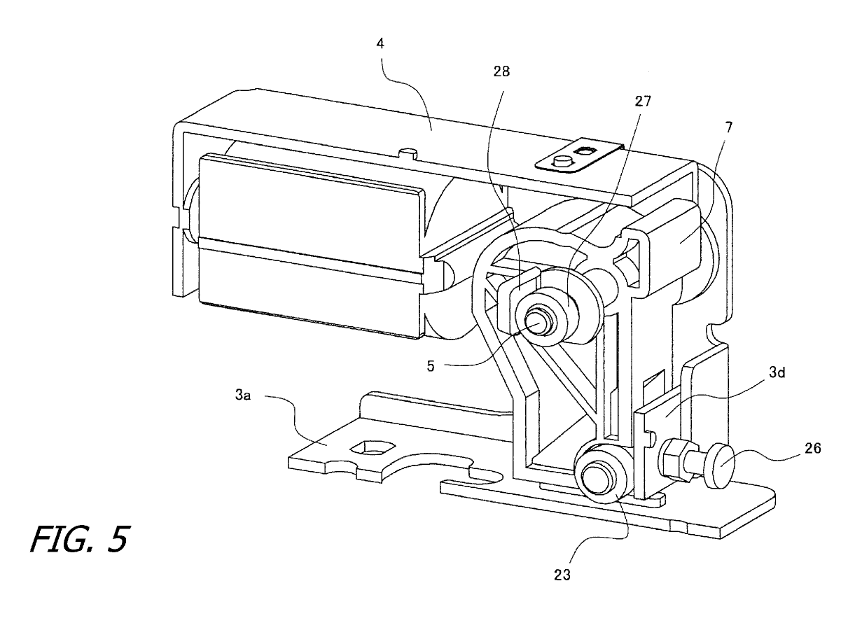

Note that to smoothly adjust the height position using the spacer member 24 in the embodiment described above, it is possible to adopt a guide structure as shown in FIG. 5 for the brake member 7. FIG. 5 shows a guide roller 23 equipped on the brake member 7. This rotates in the upward and downward directions of the drawing along the backside wall 3d (the second member) of the first mounting member 3. A rolling roller 27, such as a bearing roller, is equipped at a location on the rotary shaft 5 to engage the socket 3e. The rolling roller 27 moves upward and downward while engaging a guide rib 28 (a second guide member) bent in upward and downward directions formed around the socket 3e. In this way, it is possible to easily make height adjustments with little operating force by equipping the rolling roller between the brake member 7 that moves upward and downward and the member that guides this in upward and downward directions.

Also, a stop member that controls mutual rotating angles is disposed between the first and second mounting members 3, 4. In the drawing, the upper unit 2 is stopped by the first stop member 19 and held at a full-open position, for example at substantially a 90° angle. Then, by installing a second stop member 20, the upper unit 2 can be stopped and held at a half-open position, for example at a 60° angle. When installing the bottom wall (mounting seat) 3a of the first mounting member 3 to the top frame of the lower unit 1, the second mounting member 4 is stopped and held at the full-open state to ensure an adequate working area. After installation, the second stop member 20 stops the upper unit 2 at a predetermined angular position to make it easier to set an original on the platen of the lower unit 1, for example.

As shown in FIG. 6, a projection 19a of the first stop member 19 on one side wall (the side wall 4b of the drawing) of the second mounting member 4, engages the position 19b on the side wall (the side wall 3b in the drawing) of the first mounting member 3 to control the second mounting member 4 at the full-open position (substantially 90° in the drawing). Also, the second stop member 20 is composed of a lever member fastened by a screw to the backside wall 3d of the first mounting member 3. The second mounting member 4 is stopped at the half-open position (substantially 60 degrees in the drawing) by the projection 20b formed on the side wall of the second mounting member 4 by its engaging the leading end 20a.

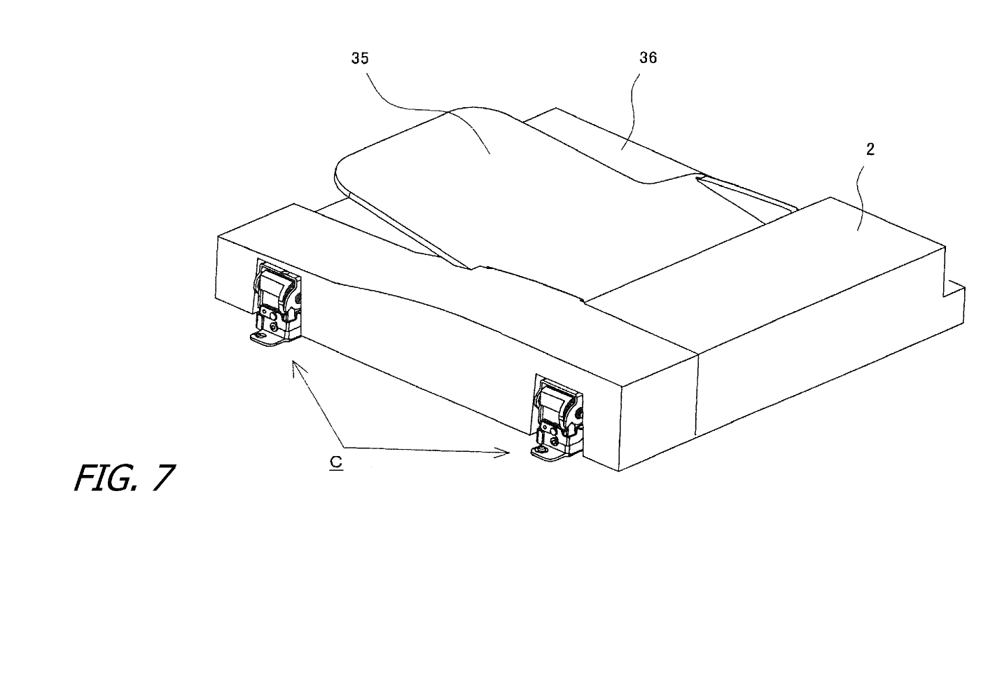

The present invention openably connects the upper unit 2, such as an automatic document feeder, to the lower unit 1, such as an image reading apparatus, using the hinge device C. This status of the connections is shown in FIG. 7. The first mounting member 3 is bolted to the device frame of the lower unit 1 at a proper number of locations. Two positions, left and right, are shown in FIG. 7. The upper unit 2 is bolted to the unit mounting surface 4d of the second mounting member 4 openably connected to the first mounting member 3 by the rotary shaft 5. For example, if the upper and lower units are temporarily installed, rotate the adjusting screw 26 to adjust the heights of the left and right hinge devices while visually opening and closing the upper unit 2 to check the degree of closeness to the lower unit 1. Adjust so that the bottom surface (described below as the original pressing member) of the upper unit 2 closely fits the top surface (described below as the original setting platen) of the lower unit 1, and securely fasten the hinge device C to both the upper and lower units in that state.

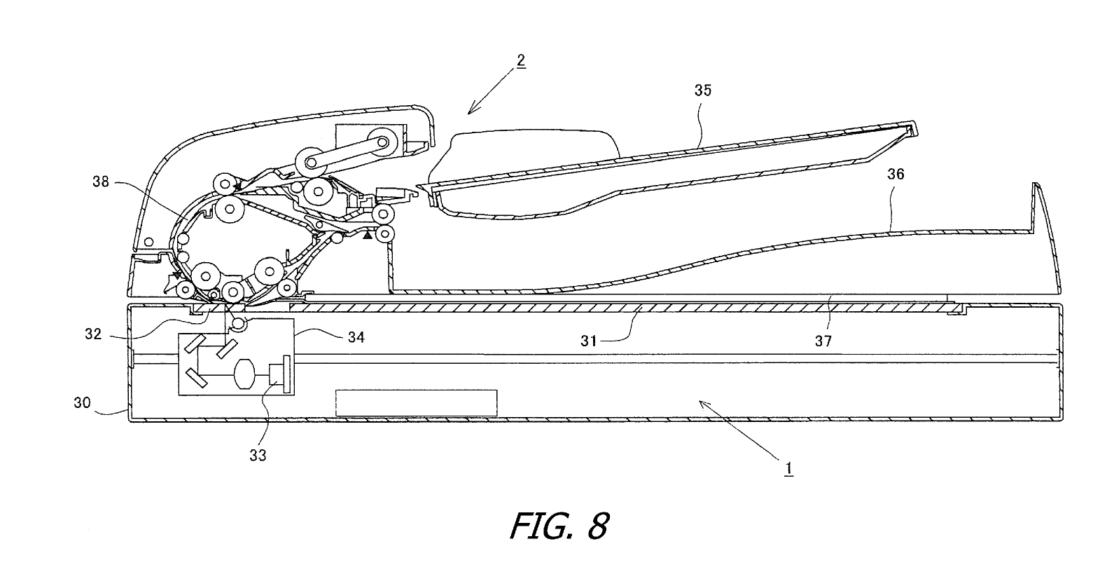

The following will explain composing the lower unit 1 with the image reading apparatus A and the upper unit 2 with the automatic document feeder B. As shown in FIG. 8, the image reading apparatus is an ordinary scanner device. At the top surface of the casing, it is equipped with a first platen 31 that is a transparent material, such as glass, for setting originals; and a second platen 32 for reading originals fed from the automatic document feeder B. A carriage 34 equipped under the platens is mounted with an image reading means 33. The carriage is mounted a with reducer type optical elements such as a light source lamp, mirrors and an imaging lens. They are supported by a guide rail, not shown, to move along the platen 31. The image reading means is composed of a line sensor, such as a CCD type photoelectric conversion element. Read image data is digitally converted at an image processing unit, then transferred to an external device, such as a copier or computer.

On the other hand, the automatic document feeder B that is configured as the upper unit 2 separates original sheets to sequentially feed one original at a time from a feeding tray 35 to the second platen 32, and stores the originals read at the platen 32 in a discharge tray 36. As shown in FIG. 7, the feeding tray 35 and discharge tray 36 are disposed so that the discharge tray 36 is below the feeding tray 35 in a substantially horizontal direction. An original pressing member 37 that covers the first platen 31 is equipped below the discharge tray 36. Therefore, when the automatic document feeder B is rotated upward, the top portion of the first platen is exposed thereby allowing an original to be placed thereupon. When the automatic document feeder B is rotated downward, the original pressing member presses downward and holds the original on the first platen 31.

A U-shaped conveyance path 38 that guides an original on the feeder tray 35 to the discharge tray 36 via the second platen 32, is equipped between the feeder tray 35 and the discharge tray 36; a conveyance roller is disposed in the conveyance path 38. Kick roller means that kicks an original out from the feeder tray 35 is disposed with an ordinary configuration of a separation roller to separate originals in single sheets. A pair of registration rollers is disposed in the conveyance path 38 at a downstream side of the feed roller to register and correct any skewing in the original fed from the roller. Therefore, the automatic document feeder B separates original prepared on the feeder tray 35 and sequentially feeds them one at a time to the second platen 32; and stores originals read at the platen in the discharge tray 36. At the same time, this automatic document feeder B is provided with a function to press and hold the original set (manually) at the first platen 31. Note that image reading means 33 scans images while traveling along the platen when an original is placed on the first platen 31, and remains still to scan images on a moving original traveling over the second platen 32.

In this way, the automatic document feeder installed to open over the image reading apparatus is heavy and may require power to open, depending on its configuration. The spring 6 lightens the weight of the upper unit 2, as described above, and is built-in to the hinge device C; the springing force of the spring 6 is set in consideration of operation by a user. When the automatic document feeder B is opened upward from the lower unit 1 at a predetermined angle (for example, 60°) the spring force is set to balance the weight of the device so the automatic document feeder is stopped at that angled position to allow the user to manually place an original on the first platen 31 without having to hold up the automatic document feeder at that position with one hand. If the force is disrupted when the balance of the device weight and springing force are balance at that predetermined angle, the automatic document feeder may fall. This problem is alleviated by using the hinge device C of the present invention.

What is claimed is:

1. A hinge device for open/closably connecting an upper unit to an upper surface of a lower unit, the hinge device comprising:
a first mounting member, for attachment to the upper surface of the lower unit;
a second mounting member, to which the upper unit is attachable;
a rotary shaft connecting said first mounting member and said second mounting member, for rotatively supporting said second mounting member with respect to said first mounting member;
a compression spring provided in between said first mounting member and said second mounting member;
a casing member supporting the end of said compression spring alongside said first mounting member;
a brake member having a cam surface for coming into contact with said casing member to brake opening/closing of the upper unit with respect to the upper surface of the lower unit; and
shift means for vertically shifting said brake member, said compression spring, and said second mounting member.

2. The hinge device according to claim 1, wherein said shift means is disposed in between said first mounting member and said brake member, and comprises:
a spacer member for vertically shifting said brake member with a sliding movement; and
an adjusting member for adjusting the sliding position of said spacer member.

3. The hinge device according to claim 2, wherein:
said brake member, said compression spring, said second mounting member, and said rotary shaft are unitarily configured; and
an elongate groove, through which said rotary shaft penetrates, is formed in side portions of said first mounting member, for vertically guiding said brake member, said compression spring, and said second mounting member unitarily.

4. The hinge device according to claim 3, wherein:
said rotary shaft supporting said second mounting member is provided in said brake member; and
a retaining part is provided on said second mounting member, for retaining said compression spring.

5. The hinge device according to claim 3, wherein:
a first roller is provided on said rotary shaft;
a first guide member is formed along the elongate hole in said first mounting member; and
said first roller abuts on said first guide member to vertically guide said brake member, said compression spring, and said second mounting member unitarily.

6. The hinge device according to claim 5, wherein:
a second roller provided on said brake member;
a second guide member is provided on said first mounting member perpendicularly; and
said second roller abuts on said second guide member to vertically guide said brake member, said compression spring, and said second mounting member unitarily.

7. The hinge device according to claim 2, wherein the lower unit is an image-reading unit including a reading platen provided in the upper surface of the lower unit, and reading means for reading an original on the reading platen.

8. The hinge device according to claim 7, wherein the upper unit is a document conveying unit for supplying originals to the reading platen provided in the upper surface of the image-reading unit.

9. A hinge device for open/closably connecting an upper unit to a lower unit, the hinge device comprising:
a first mounting member, for attachment to the lower unit;
a second mounting member, for attachment to the upper unit;
a rotary shaft connecting said first mounting member and said second mounting member;
a compression spring disposed on said second mounting member, for swinging said first and second mounting members, with said rotary shaft as center, in the direction in which said spring widens;
a casing member supporting one end of said compression spring, and having a pressing engager; and
a brake member having a cam surface for on said pressing engager to restrict the elastic force of the compression spring; wherein
said brake member and said rotary shaft are supported on said first mounting member for free position adjustment to vary the height position of the upper unit; and
a shift means is provided in between said brake member and said first mounting member, for shifting vertically in the height direction the axle-support position of said rotary shaft, and the position where said pressing engager and said cam surface engage.

10. The hinge device according to claim 9, wherein said shift means is disposed in between said first mounting member and said brake member, and comprises:
a spacer member for vertically shifting said brake member with a sliding movement; and
an adjusting member for adjusting the sliding position of said spacer member.
